(19) United States
(12) Patent Application Publication
(10) Pub. No.: US 2015/0328792 A1
(43) Pub. Date: Nov. 19, 2015

(54) STRETCH FILM CUTTER

(71) Applicant: Yu-Chun HUANG, Taichung City (TW)

(72) Inventor: Yu-Chun HUANG, Taichung City (TW)

(21) Appl. No.: 14/277,495

(22) Filed: May 14, 2014

(51) Int. Cl. B26B 29/02; B26B 5/00

(52) U.S. Cl. CPC B26B 29/02; B26B 5/00

(57) ABSTRACT

A stretch film cutter includes a hand-hold body defining an opening, a swivel member pivotally connected to the hand-hold body near the opening and turnable relative to the hand-hold body between a first angular position where the swivel member blocks the opening of the hand-hold body and a second angular position where the swivel member is kept away from the opening of the hand-hold body, and a cutter holder holding two cutter blades in the opening of the hand-hold body at two opposite lateral sides in a substantially V-shaped configuration to provide enhanced shear force for cutting an opening out of a wrapped stretch film for easy removal of the wrapped stretch film. The swivel function of the swivel member facilitates replacement or adjustment of the cutter blades and reduces the risk of accidental worker injury, achieving the objects of the present invention.

### BACKGROUND OF THE INVENTION

1. Field of the Invention

The present invention relates to cutting technology and more particularly, to a stretch film cutter for cutting a stretch film.

2. Description of the Related Art

Conventional stretch films for shrink wrapping and packaging products commonly have the physical properties of anti-buffering strength, extension strength and self-adhesivity. When conventional stretch films are used to wrap products either manually or by means of a semi-auto wrapping machine or fully automatic wrapping machine, they indirectly provide high tear resistance and high puncture resistance, enhancing primary protection, such as surface protection of the packaged goods, dust, oil, moisture-proof, waterproof and anti-theft protections as well as stress concentration prevention.

When going to detach a wrapped stretch film from the wrapped goods, a sharp tool (such as cutter knife, scissors, etc) shall be used to pierce, shear or cut the wrapped stretch film, making an opening out of the wrapped stretch film so that the wrapped stretch film can be removed from the wrapped goods. However, using a sharp tool to pierce, shear or cut an opening out of the wrapped stretch film can damage the wrapped goods accidentally if the applied force is not properly controlled or the location of destruction on the wrapped stretch film is not properly selected. Further, the worker can easily be injured by the sharp tool during operation. Therefore, an improvement in this regard is necessary.

### SUMMARY OF THE INVENTION

The present invention has been accomplished under the circumstances in view. It is the main object of the present invention to provide a stretch film cutter, which facilitates stretch film cutting operation.

To achieve this and other objects of the present invention, a stretch film cutter comprises a hand-hold body defining an opening that has a width gradually reducing in direction from the periphery of the hand-hold body toward an inner side thereof, a swivel member pivotally connected to the hand-hold body near the opening and turnable relative to the hand-hold body between a first angular position where the swivel member blocks the opening of the hand-hold body and a second angular position where the swivel member is kept away from the opening of the hand-hold body, and a cutter holder having two cutter blade holder portions disposed in the opening of the hand-hold body at two opposite lateral sides.

In the stretch film cutter, two cutter blades are respectively mounted in the two cutter blade holder portions of the cutter holder to have the cutting edges thereof obliquely face toward each other in a substantially V-shaped configuration for providing enhanced shear force to facilitate cutting an opening out of a wrapped stretch film for easy removal of the wrapped stretch film. Preferably, the swivel member is pivotally mounted with a front seat member and a protective member to facilitate replacement or adjustment of the cutter blades and also to reduce the risk of accidental worker injury, thereby achieving the objects of the present invention.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a stretch film cutter in accordance with the present invention.

FIG. 2 is an exploded view of the stretch film cutter in accordance with the present invention.

FIG. 3 is a schematic sectional side view illustrating the stretch film cutter in a first operational action in accordance with the present invention.

FIG. 4 is an enlarged view of a part of the stretch film cutter in the first operational action in accordance with the present invention.

FIG. 5 is a schematic sectional side view illustrating the stretch film cutter in a second operational action in accordance with the present invention.

FIG. 6 is a schematic sectional side view illustrating the stretch film cutter in a third operational action in accordance with the present invention.

FIG. 7 is an enlarged view of a part of the stretch film cutter in the third operational action in accordance with the present invention.

FIG. 8 is a schematic sectional side view illustrating the stretch film cutter in a fourth operational action in accordance with the present invention.

### DETAILED DESCRIPTION OF THE INVENTION

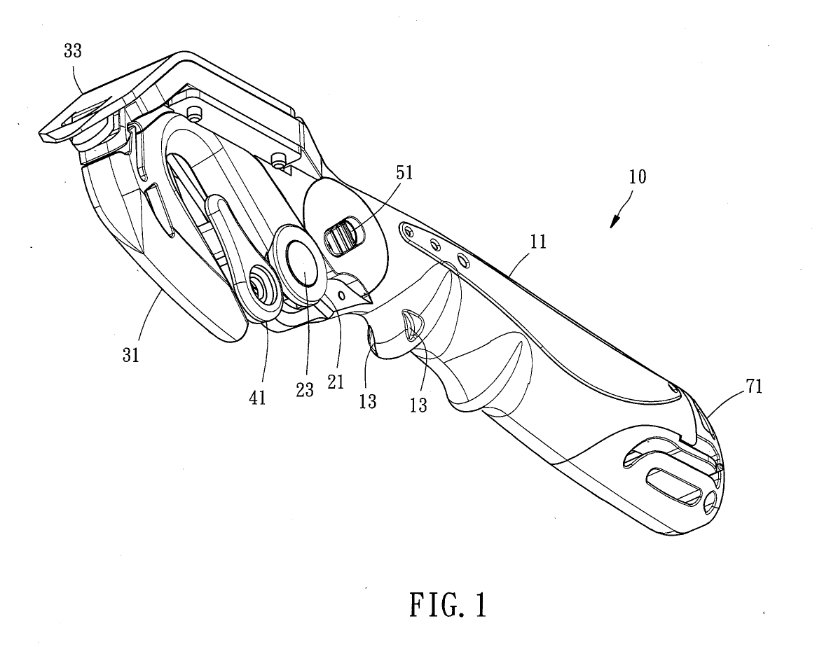

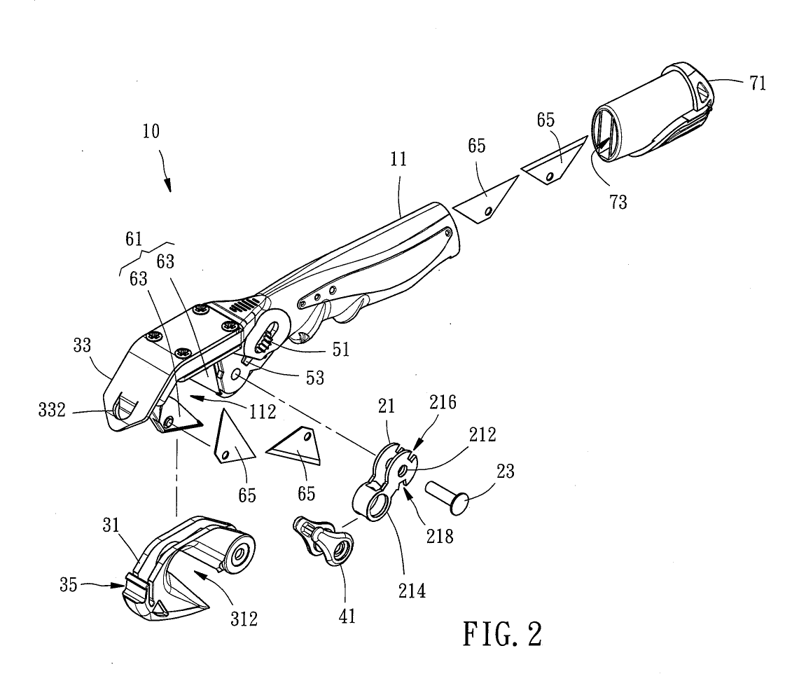

Referring to FIGS. 1 and 2, a stretch film cutter 10 in accordance with the present invention is shown. The stretch film cutter 10 comprises:

a hand-hold body 11 comprising an opening 112 having a width gradually reducing in direction from the periphery toward an inner side thereof, and at least one, for example, two receiving slot s 13 located in the periphery thereof;

a swivel member 21 pivotally connected to one side of the hand-hold body 11 adjacent to the opening 112, comprising a first pivot-connection portion 212 on one end and a second pivot-connection portion 214 on other end, a first position-limit groove 216 and a second position-limit groove 218;

a front seat member 31 pivotally connected with the first pivot-connection portion 212 of the swivel member 21 to the hand-hold body 11 by a pivot pin 23, comprising a recessed hole 312 mating with the opening 112 of the hand-hold body 11 and a locating groove 35 located at a front side thereof;

a top cover 33 connected with a rear end thereof to the front seat member 31 and adapted for detachably fastening to a rivet or locating member of the product to be packed, comprising a retaining portion 332 extended from an opposing front end thereof and engageable in the locating groove 35 of the front seat member 31;

a protective member 41 pivotally connected to the second pivot-connection portion 214 of the swivel member 21 and having a tapered configuration mating with the width of the opening 112 of the hand-hold body 11;

a stopper member 51 comprising a locating rod 53 adapted for engaging into the first position-limit groove 216 of the swivel member 21 upon rotation of the swivel member 21 relative to the hand-hold body 11 to a first angular position, or the second position-limit groove 218 of the swivel member 21 upon rotation of the swivel member 21 relative to the hand-hold body 11 to a second angular position;

a cutter holder 61 mounted in the hand-hold body 11, comprising two cutter blade holder portions 63 respectively disposed in the opening 112 of the hand-hold body 11 at two opposite lateral sides and two cutter blades 65 respectively mounted in the cutter blade holder portions 65 to have the cutting edges thereof obliquely face toward each other in a substantially V-shaped configuration; and

a compartment 71 located at one end of the hand-hold body 11 and defining therein a storage chamber 73 for storing spare cutter blades 65.

After described the structural features of the components of the stretch film cutter 10, the functioning of the stretch film cutter 10 is outlined hereinafter.

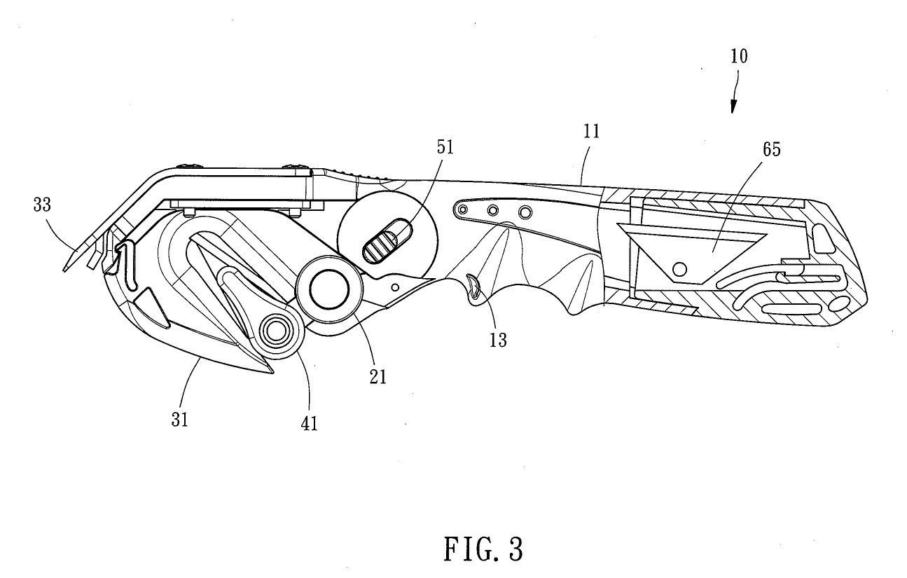

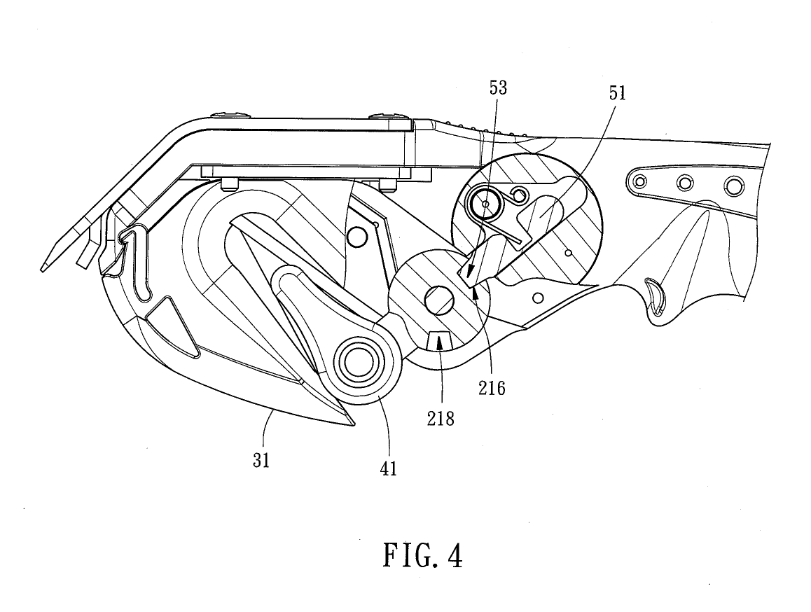

Referring to FIGS. 3 and 4 and FIGS. 1 and 2 again, a first operational action of the stretch film cutter 10 is illustrated. This first operational action enables the stretch film cutter 10 to enter a protective status. When biased the swivel member 21 of the stretch film cutter 10 to the first angular position, the protective member 41 that is pivotally connected to the second pivot-connection portion 214 of the swivel member 21 is press-fitted into the opening 112 of the hand-hold body 11. At this time, the locating rod 53 of the stopper member 51 is moved toward and engaged into the first position-limit groove 216 of the swivel member 21.

As stated above, when the stretch film cutter 10 entered the protective status, the protective member 41 is press-fitted into the opening 112 of the hand-hold body 11 to prohibit the cutter blades 65 in the cutter blade holder portions 63 of the cutter holder 61 from being touched by the user, preventing accidental injury and achieving the expected efficacy and purpose of the present invention.

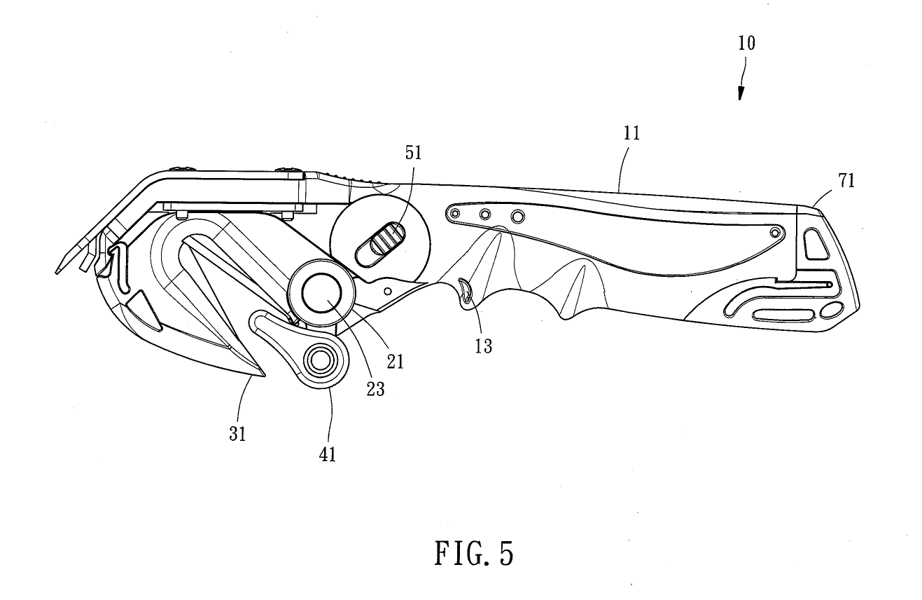

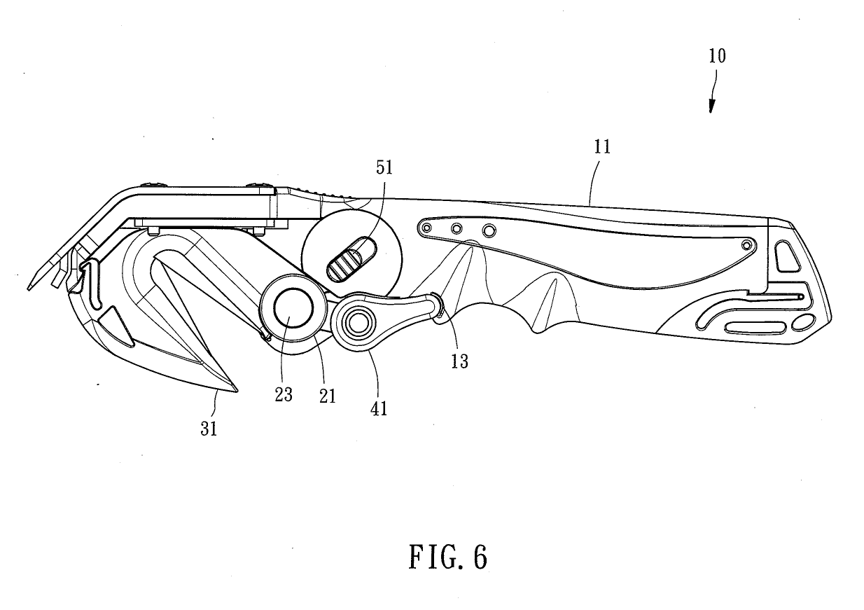

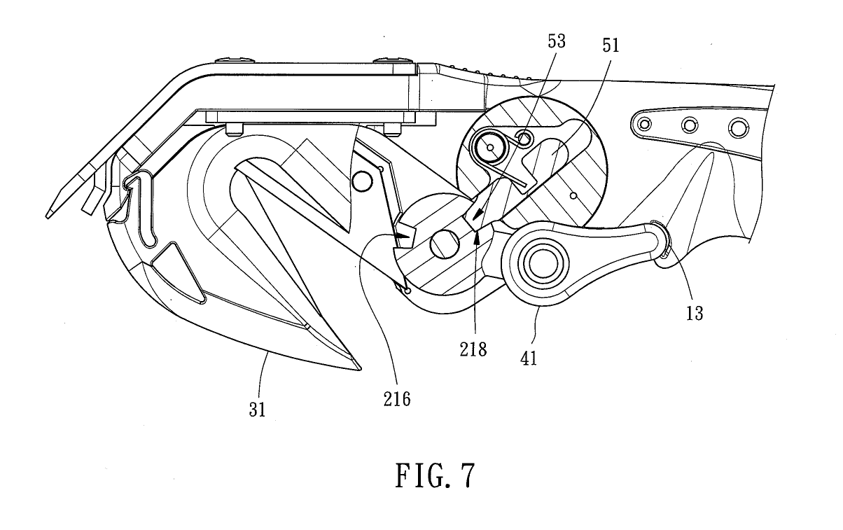

Referring to FIGS. 5-7 and FIGS. 1 and 2 again, second and third operational actions of the stretch film cutter 10 are illustrated. Through these second and third operational actions, the stretch film cutter 10 is ready for performing a cutting operation. At first, move the locating rod 53 of the stopper member 51 in direction away from the first position-limit groove 216 of the swivel member 21 to disconnect the stopper member 51 from the swivel member 21. Thereafter, the protective member 41 is moved with the second pivot-connection portion 214 of the swivel member 21 out of the opening 112 of the hand-hold body 11. When the swivel member 21 reached the second angular position, the tapered rear end of the protective member 41 is forced into the receiving slot s 13 of the hand-hold body 11. At this time, the locating rod 53 of the stopper member 51 is moved into the second position-limit groove 218 of the swivel member 21.

Thus, through the aforesaid second and third operational actions, the stretch film cutter 10 is set in the operational status for performing a cutting operation. By means of the swivel action of the swivel member 21, the protective member 41 is moved out of the opening 112 of the hand-hold body 11. At this time, the cutting edges of the two cutter blades 65 in the cutter holder 61 are obliquely disposed to face toward each other in a substantially V-shaped configuration to provide enhanced shear force for cutting an opening out of a wrapped stretch film for easy removal of the wrapped stretch film to achieve the expected efficacy and purpose of the present invention.

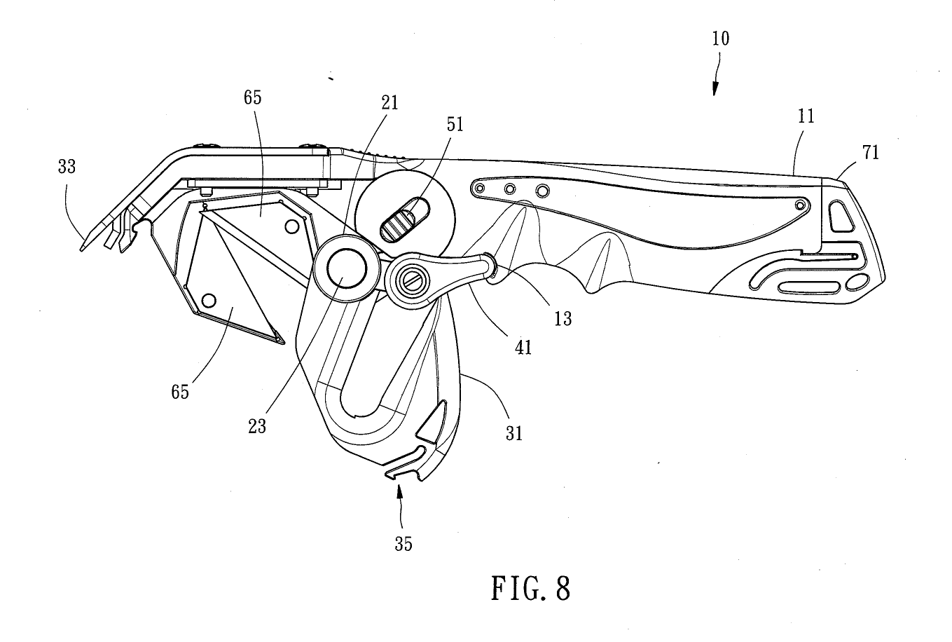

Referring also to FIG. 8, a fourth operational action of the stretch film cutter 10 is illustrated. This fourth operational action enables the stretch film cutter 10 to enter the configuration for replacement of the cutter blades 65 or loading of new cutter blades. At first, move the locating groove 35 of the front seat member 31 in direction away from the retaining portion 332 of the top cover 33. Because the front seat member 31 is coaxially pivotally connected with the swivel member 21 to the hand-hold body 11, the front seat member 31 can be biased in direction away from the top cover 33. At this time, the user can adjust or replace the cutter blades 65 in the cutter holder 61 inside the hand-hold body 11 subject to their wear condition. Preferably, multiple spare cutter blades 65 are stored in the compartment 71 at the rear end of the hand-hold body 11. Through the aforesaid fourth operational action, the user can replace the cutter blades 65 or add new cutter blades, thereby achieving the expected efficacy and purpose of the present invention.

In conclusion, the prevent invention provides a stretch film cutter 10, wherein two cutter blades 65 are respectively mounted in the two cutter blade holder portions 63 of the cutter holder 61 to have the cutting edges thereof obliquely face toward each other in a substantially V-shaped configuration capable of providing enhanced shear force for cutting an opening out of a wrapped stretch film to facilitate removal of the wrapped stretch film. Preferably, the swivel member 21 of the stretch film cutter 10 is pivotally mounted with the front seat member 31 and the protective member 41 to facilitate replacement or adjustment of the cutter blades 65 and also to reduce the risk of accidental worker injury, thereby achieving the objects of the present invention.

Except the aforesaid embodiment, the stretch film cutter of the present invention can also be variously embodied.

In the aforesaid embodiment, the recessed hole of the front seat member 31 has a U shape. Alternatively, the recessed hole of the front seat member 31 can be made gradually reducing in width in direction from an outer side toward an inner side thereof.

In the aforesaid embodiment of the present invention, the second pivot-connection portion 214 of the swivel member 21 is pivotally connected with the protective member 41. Alternatively, the protective member 41 and the front seat member 31 can be coaxially pivotally connected with the swivel member 21 to the hand-hold body 11 by the pivot pin 23.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A stretch film cutter, comprising:
a hand-hold body (11), said hand-hold body (11) comprising an opening (112), said opening (112) having a width gradually reducing in direction from the periphery of said hand-hold body (11) toward an inner side of said hand-hold body (11);
a swivel member (21) pivotally connected to said hand-hold body (11) near said opening (112) and turnable relative to said hand-hold body (11) between a first angular position where said swivel member (21) blocks said opening (112) of said hand-hold body (11) and a second angular position where said swivel member (21) is kept away from said opening (112) of said hand-hold body (11); and
a cutter holder (61), said cutter holder (61) comprising two cutter blade holder portions (63) respectively disposed two opposite lateral sides in said opening (112) of said hand-hold body (11).

2. The stretch film cutter as claimed in claim 1, wherein said swivel member (21) comprises a first pivot-connection portion (212), a pivot pin (23) pivotally connecting said first pivot-connection portion (212) to said hand-hold body (11), and a second pivot-connection portion (214) pivotally connected with a protective member (41).

3. The stretch film cutter as claimed in claim 1, wherein said swivel member (21) is engaged in said hand-hold body (11) when biased to said second angular position.

4. The stretch film cutter as claimed in claim 2, wherein said hand-hold body (1.1) further comprises at least one receiving slot (13) adapted for receiving said swivel member (21) in said second angular position.

5. The stretch film cutter as claimed in claim 2, wherein said protective member (41) has a tapered configuration fitting the width of said opening (112) of said hand-hold body (11).

6. The stretch film cutter as claimed in claim 1, further comprising a front seat member (31), said front seat member (31) comprising a recessed hole (312) mating with said opening (112) of said hand-hold body (11).

7. The stretch film cutter as claimed in claim 6, further comprising a top cover (33), said top cover (33) comprising a retaining portion (332) engaged in a locating groove (35) of said front seat member (31).

8. The stretch film cutter as claimed in claim 1, wherein said swivel member (21) further comprises at least one first position-limit groove (216) adapted for engagement with a stopper member (51) in said hand-hold body (11) to hold said swivel member (21) in said first angular position.

9. The stretch film cutter as claimed in claim 2, wherein said swivel member (21) further comprises at least one first position-limit groove (216) adapted for engagement with a stopper member (51) in said hand-hold body (11) to hold said swivel member (21) in said first angular position.

10. The stretch film cutter as claimed in claim 1, wherein said swivel member (21) further comprises at least one second position-limit groove (218) adapted for engagement with a stopper member (51) in said hand-hold body (11) to hold said swivel member (21) in said second angular position.

11. The stretch film cutter as claimed in claim 2, wherein said swivel member (21) further comprises at least one second position-limit groove (218) adapted for engagement with a stopper member (51) in said hand-hold body (11) to hold said swivel member (21) in said second angular position.

12. The stretch film cutter as claimed in claim 1, wherein said swivel member (21) is coaxially pivotally mounted with a front seat member (31).

13. The stretch film cutter as claimed in claim 2, wherein said swivel member (21) is coaxially pivotally mounted with a front seat member (31).
